(19) United States
(12) Patent Application Publication
(10) Pub. No.: US 2008/0062069 A1
(43) Pub. Date: Mar. 13, 2008

(54) Personal Video Display Device

(75) Inventors: Ian Sinclair, Indian Falls, NY (US); Steven D. Smith, Rochester, NY (US); Vincent J. Ferrer, Macedon, NY (US); Paul Travers, Honeoye Falls, NY (US)

Correspondence Address: Stephen B. Salai, Esq.;Harter, Secrest & Emery LLP, 1600 Bausch & Lomb Place, Rochester, NY, 14604-2711, US

(73) Assignee: Icuiti Corporation, Rochester, NY (US)

(21) Appl. No.: 11/470,985

(22) Filed: Sep. 7, 2006

(51) Int. Cl. G09G 5/00

(52) U.S. Cl. 345/8

(57) ABSTRACT

A personal video display device includes first and second display screens and a controller connected to the screens for showing video signals received from a source. The controller selectively switches between a two-dimensional mode and a three-dimensional mode based solely on the received video signals.

### BACKGROUND OF THE INVENTION

1. Field of the Invention

This invention relates generally to personal video displays and more particularly to a personal video display of the wearable type that receives two-dimensional or three-dimensional video signals and optional data signals and automatically switches between two-dimensional and three-dimensional display modes based solely on the received signals.

2. Description of Related Art

Portable devices for playing video signals such as the Apple iPod, the Archos Multi Media Player, and many cellular phones with video capabilities are becoming increasingly common. These devices have the capability for playing videos through conventional televisions or other large displays, but users generally rely on the players' built-in displays. Recently, relatively economical binocular personal viewers have become available that are worn by users in a manner similar to eye glasses and which include a pair of displays, one for each eye, which display video signals recorded on the personal devices in a manner that creates a virtual screen that is much larger than the screens built in to the devices.

Applicants have discovered that, although not generally used for such a purpose, it is possible to store videos on personal players of the type described that can be played as three-dimensional videos. Specifically, the personal viewers just described are in practice capable of displaying three-dimensional videos from such personal devices if the viewers are configured appropriately.

However, there is a need in the art for a method and apparatus for automatically switching between a two-dimensional and a three-dimensional display of videos on personal video displays.

### BRIEF SUMMARY OF THE INVENTION

Applicants' invention addresses the above-described needs in the art by providing a personal video display device capable of automatically displaying both two and three dimensional videos.

For example, in one aspect of the present invention, a personal video display device includes first and second display screens and a controller. The controller is connected to the screens for showing video signals received from a source. The controller selectively switches between a 2D mode and a 3D mode solely based on the received video signals.

In another aspect of the present invention, a personal display device includes first and second display screens and a controller receiving video signals and data signals. The controller switches between displaying the video signals on the first and second display screens in a 2D mode and a 3D mode based on the data signals.

In a still further aspect of the present invention, a method of displaying video on a personal video display device having first and second display screens, includes a receiving step of receiving video content including video signals in the video display device from a source and selecting whether the video signals should be displayed on the personal video display device in one of a two-dimensional mode and three-dimensional mode. Identical video signals are displayed at the same time on each of the first and second display screens when the two-dimensional mode is selected in the selecting step. Different video signals are displayed at the same time on each of the first and second display screens when the three-dimensional mode is selected in the selecting step.

An understanding of these and other features of the invention may be had with reference to the attached Figures and following description, in which the present invention is illustrated and described.

### BRIEF DESCRIPTION OF THE SEVERAL VIEWS OF THE DRAWING(S)

FIG. 1 is a perspective view of a personal video display device according to a preferred embodiment of the present invention.

FIG. 2 is a side plan view of a personal video display device according to another preferred embodiment of the present invention.

FIG. 3 is a schematic diagram depicting data transfer between a video source and a personal video display device according to an embodiment of the invention.

FIG. 4 is a schematic diagram depicting data transfer between a video source and a personal video display device according to another embodiment of the invention.

FIG. 5 is a schematic diagram depicting data transfer between a video source and a personal video display device according to a further embodiment of the invention.

FIG. 6 is a schematic diagram depicting data transfer between a video source and a personal video display device according to a still further embodiment of the invention.

FIG. 7 is a schematic diagram depicting data transfer between a video source and a personal video display device according to a still further embodiment of the invention.

### DETAILED DESCRIPTION OF THE INVENTION

Preferred embodiments of the invention will now be described with reference to the accompanying figures.

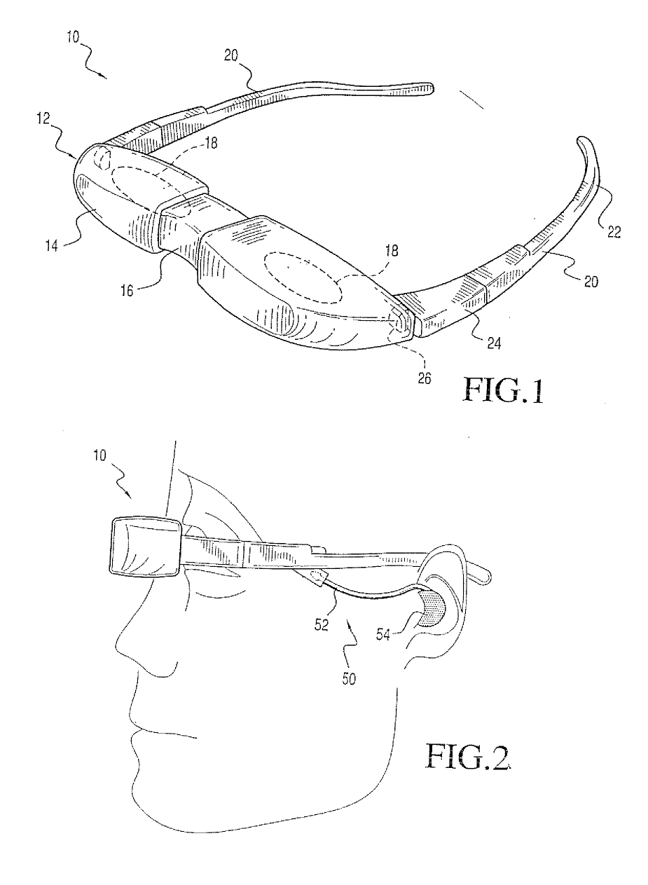

FIGS. 1 and 2 depict embodiments of a personal video display device 10. The display device includes a binocular frame 12, including a front frame 14 and a nose piece 16 for supporting a display screen 18 in front of each eye. The display screens 18 preferably are micro displays such as described in the co-pending application MICRO DISPLAY ENGINE, co-owned by the assignee of the present application. The binocular frame 12 attaches to a pair of bows 20. Each bow 20 has a back piece 22, a front piece 24, and a pivotal connector 26.

As shown in FIG. 2, the personal video display device 10 also may include an earpiece 50 attached to the bow 20 of the video device 10. The earpiece 50 preferably includes a speaker 54 for insertion into a user's ear suspended from the bow 20 of the imaging device by a boom 52. Of course, two earpieces 50 may be included, one for each ear.

Devices such as those shown in FIGS. 1 and 2 are readily available in the marketplace, and may be used to view video signals. Specifically, these conventional imaging devices display a video signal received from a signal source on the two display screens. In a preferred embodiment, a signal source transmits video signals to the virtual display imaging device 10. Preferably, the video signals are transmitted from the source to the display imaging device through a wired connection. Audio signals also may be sent from the same or a different signal source via wired connection to the imaging device 10 for broadcasting through the speaker 54. Known wireless communications also may be employed to transmit one or both of the video signals and the audio signals to the display imaging device.

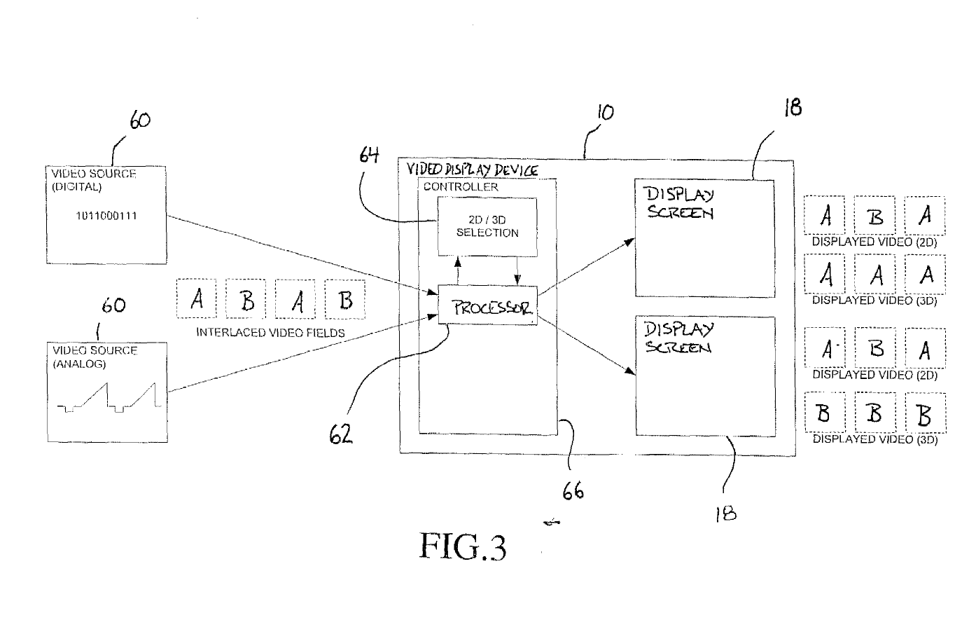

As schematically illustrated in FIG. 3, in a preferred embodiment of the invention a video source 60 provides video content to the video display device. The video signal may be supplied in either an analog format or a digital format, and preferably includes alternating, interlaced video fields A, B.

When the described interlaced video fields A, B are displayed on a single display screen, for example, a display screen integrated in a personal portable media player such as an Apple iPod, the interlaced video fields are played in interlaced succession, A, B, A, B, . . . , to display a two-dimensional video on the screen. The video signals may be similarly displayed in a two-dimensional manner on a virtual display imaging device such as that described above. Particularly, the interlaced video fields provided by the video source are played identically, i.e., in interlaced succession, A, B, A, B, . . . , on both screens simultaneously. Accordingly, each eye sees the same image at substantially the same time when one of the display screens is arranged to correspond to the right eye and the other of the display screens is arranged to correspond to the left eye.

The video display device 10 also can display video signals in three-dimensions using the two screens 18. Specifically, when the virtual display imaging device receives the interlaced video fields A, B described above, the device can process and control the signals such that all A fields are displayed on the first display screen seen by the right eye and all B fields are displayed on the second display screen seen by the left eye. In this manner, each eye sees a different image at the same time, allowing for standard, or normal, three-dimensional viewing. Conversely, the video may be displayed in reverse three-dimension, i.e., with all A fields being displayed on the display screen seen by the left eye and all B fields being displayed on the display screen seen by the right eye. As will be appreciated by those of ordinary skill in the art, in order for a three-dimensional image to be produced the A and B fields must contain images that when viewed by the left and right eye separately, create a three-dimensional image. The methods of forming these images are well-known and do not, per se, form any part of this invention.

As shown in more detail in FIGS. 3-7, the personal video display device preferably includes a processor 62 that receives the video signals from the video source and that transmits the video signals to the display screens for display. The display device preferably also includes a selector 64 in communication with the processor to select whether the video signals should be transmitted to the display screens 18 for two-dimensional display or for three-dimensional display. The processor 62 and the selector 64 may be contained separately in the display device or may comprise components of a single controller. Preferably, the processor 62, the selector 64, and/or the controller 66 are contained within the frame of the video display device 10. However, some or all of these components may comprise a separate unit attached to an external surface of the personal video display device or to a wire connecting the display device to the video source, or by a wireless connection.

Thus, as illustrated in FIG. 3, video signals are received from a video source for display on two display screens. Based solely on the video signals, the selector determines whether the signals from the video source represent a two-dimensional video image or a three-dimensional video image and selects whether to display the information on the display screens in a two-dimensional format or in a three-dimensional format. For example, the selector may compare successive fields and determine from the comparison whether the video signals may be displayed in two-dimensions or in three-dimensions. Alternatively, the selector may compare corresponding lines in the successive fields to determine whether the video signals represent a two-dimensional or three-dimensional image and which format should be used to display the information.

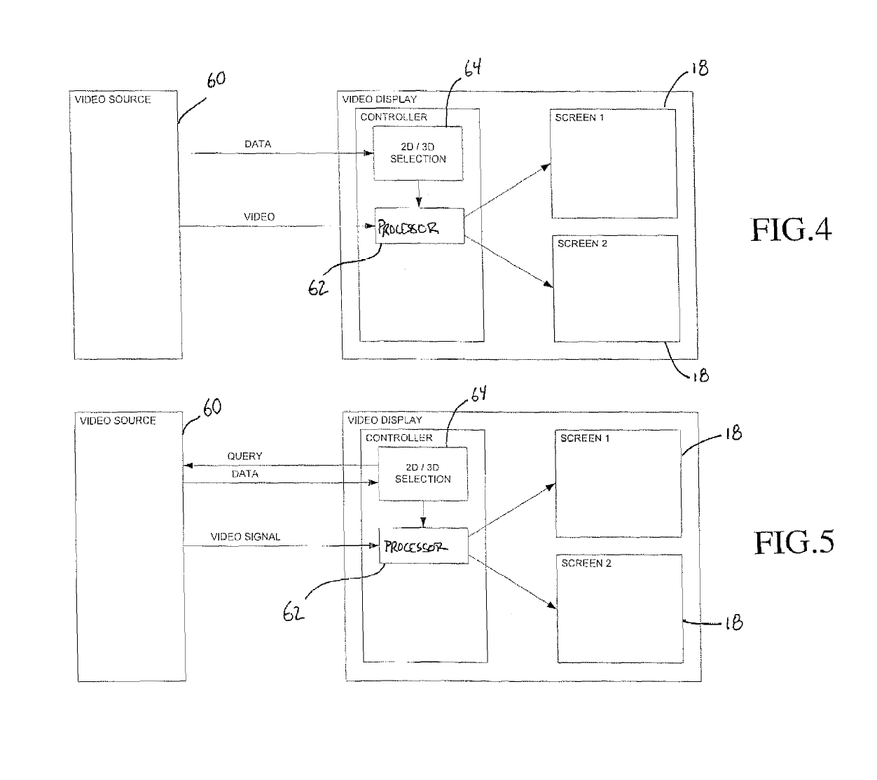

FIG. 4 depicts another preferred embodiment of the present invention. Similar to FIG. 3, a video display device 10 receives video content from a video source 60, such as a portable multimedia device. However, in FIG. 4, the content transmitted from the video source contains both a video signal and additional data. In this embodiment, the additional data is data relating to whether the corresponding video signal should be displayed in either a two-dimensional format or a three-dimensional format. The additional data may take any of a wide variety of forms. It may be video data, it may be text data, it may be digital or analog data. Upon receipt of the additional data, the selector 66 associated with the video display device 10 instructs the processor 66 to render the input video signal on the first and second display screens 18 in either two- or three-dimensions depending upon the data received.

FIG. 5 illustrates an embodiment of the invention similar to that of FIG. 4. However, in FIG. 5, the additional data is not transmitted with the video signal. The additional data is transmitted only upon request from the controller. The request may be sent periodically or asynchronously such as when a video signal is received by the processor 62 and synchronized, the processor 62 instructs the selector to query the video source for the additional data relating to whether the video signal may be displayed two- or three-dimensionally. Upon receipt of such additional data, the selector 64 instructs the processor to transmit the video signals to the first and second display screens 18 in either two- or three-dimensional formatting.

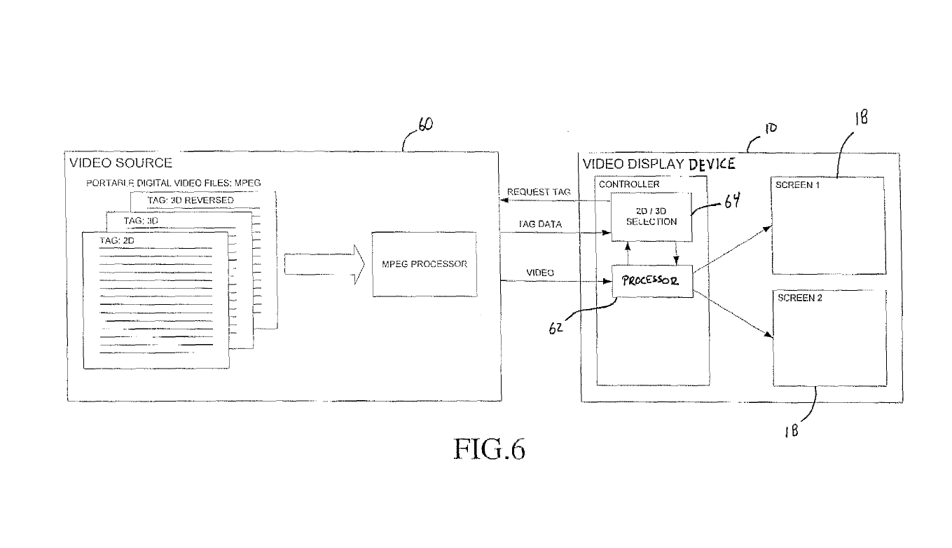

In an alternative embodiment of the invention, FIG. 6 illustrates that the video source supplies MPEG files as video content to the video display device. MPEG-4 is well known in the art as a standardized compression format for transporting video and audio signals. As also known, MPEG files may contain tags containing information associated with the video and/or audio signals contained in the MPEG file. For example, a “title” tag may include information regarding the title of a song or movie, or where appropriate, the title of a chapter of a movie contained in the file. As a further example, an “artist” tag may include information relating to the singer of a song. Applicants have found, however, that a tag may also be encoded with information indicating whether a video signal may be displayed in two- or three-dimensions. This information may be contained in a new tag added to an MPEG file containing a video signal, or may be written into an already existing tag. As a specific example, Applicants have discovered that a “composer” tag found in many MPEG files is infrequently used. Accordingly, information relating to whether the video can be displayed in two- or three-dimensions may be written into the composer tag, without disrupting normal usability and functionality of the MPEG file. The information may take a variety of forms. The information may be provided in a tag not used for other purposes or may be encoded on a tag that also conveys other information. For example, but not by way of limitation, a tag that contains information relating to the length of the video could convey information to the controller that the video is a two-dimensional video by adding a leading space to the length or a three-dimensional video by providing no leading space. Many alternatives will suggest themselves to those skilled in the art.

As illustrated in FIG. 6, the video source 60 stores MPEG files. When the MPEG files are transferred to the video display device 10 for displaying, the processor 62 receives and synchronizes the video signals contained in the files. Upon synchronization, the processor 62 preferably instructs the selector 64 to request a tag from the video source containing information relating to whether the video may be displayed in either two- or three-dimensional formatting. Upon receipt of the tag, the selector 64 selects which format the video signals are to be played in, and the processor transmits video fields to the first and second display screens 18 accordingly.

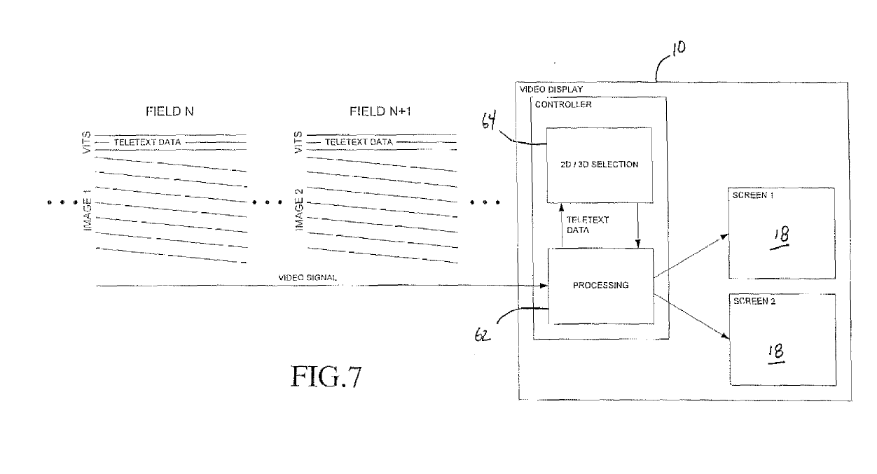

As a further alternative embodiment of the invention, information relating to whether a video may be displayed in two- or three-dimensions may also be contained in teletext data transmitted with an image comprising the video signal. Such an embodiment is illustrated in FIG. 7. As shown, the selector 64 reads the teletext data to determine whether the processor 62 should display the video on the display screens 18 in two- or three-dimensional format. By way of example, the teletext data may be contained on information supplied to the portable video player from a DVD played on a DVD player.

According to each of the above-described embodiments of the invention, a virtual image display device renders video on two display screens, one corresponding to each of a user's right and left eyes, in either two-dimensional format or three-dimensional format. Information indicating whether the video should be displayed in a two- or three-dimensional format is preferably contained with the video on the video source and is transmitted to the video display device with the video signals or separately from the video signals. In each embodiment, however, a selector associated with the display device automatically determines whether the content is to be displayed two- or three-dimensionally. Notably, no user interaction is required to determine whether to display the video in two- or three-dimensions.

According to a specific example, the video display device of the present invention is usable with a video iPod. The display device preferably includes a plug for insertion into a port on the iPod device. The mating of the plug with the port establishes a connection between the two devices, allowing for transfer of video signals, data signals, and/or power, or the like, therebetween.

When a user selects a video on the iPod, video information contained in the MPEG file is decoded and corresponding video signals are transmitted to the video display device. Upon receipt and synchronization of the video file from the video iPod, a controller contained on the video display device queries the iPod for a tag containing information regarding whether the video should be displayed two- or three-dimensionally. If the tag indicates that the video can be displayed on the display screens in three-dimensions, the selector informs the processor to so display the video. Alternatively, if the tag indicates that the video is to be displayed two-dimensionally, or if the tag is non-existent or does not include information regarding the display format, the selector informs the processor to display the video two-dimensionally.

Video files generally are contained on a video iPod in a 320×240 format, because the screen on a video iPod is 320 pixels×240 pixels. Similarly, each of the display screens on the preferred video display device of the present invention is 320 pixels×240 pixels. As is known, video may alternatively be stored on an iPod in a 320×480 format. When stored in a 320×480 format, the processor contained in the video display device according to the present invention parses out A and B fields, each 320×240, with the A and B fields corresponding to those described above with reference to FIG. 3. In this manner, a three-dimensional display can be achieved by displaying the A fields on the first display screen and the B fields on the second display screen.

In a preferred embodiment, the information regarding whether the video is to be displayed in two- or three-dimensions is pre-existing in a tag of the video file. That is, it is preferred that the content provider will encode a tag with this information prior to offering the content to an end-user, in the same manner in which tags are currently used to identify track titles and artist names on CDs and for-purchase audio and video files. However, it is also possible that an existing tag may be modified by a skilled end-user to include information used by a video display device to display video in three-dimensions. For example, Applicants have found that a “composer” tag may be re-written to provide information about whether video information should be displayed in two-dimensions or three-dimensions.

Of course, the portable video display device of the present invention is not limited to displaying video signals from an iPod. Any source of video content, including, but not limited to, DVD players, cellular phones, game consoles, and other sources of video may be employed, as will be appreciated by those of ordinary skill in the art.

As used throughout the application, the term “video” is not intended to be limited to motion pictures. The term video is intended to include any moving images or sequences of related still images including motion picture content, still video content, gaming content, graphic content, and the like. Moreover, the term “video signal” is meant to include any analog signal, digital signal, wireless signal, stream, or the like capable of transmitting video content.

The foregoing embodiments of the invention are representative of embodiments of the present invention and are provided only for illustrative purposes. The embodiments are not intended to limit the scope of the invention. Variations and modifications are apparent from a reading of the preceding description and are included within the scope of the invention. The invention is intended to be limited only by the scope of the accompanying claims.

1. A video display comprising:
first and second display screens;
a controller connected to the screens for showing video signals received from a source, the controller selectively switching between a 2D mode and a 3D mode solely based on the received video signals.

2. The video display described in clam 1 wherein the video signal is digital.

3. The video display defined in claim 1 wherein the video signal is analog.

4. The video display defined in claim 1 wherein the video signal comprises alternating video frames and the controller switches between the 2D and 3D modes based on a comparison of the two or more sequential frames.

5. The video display defined in claim 4 wherein the comparison is based on differences between corresponding lines in the sequential frames.

6. The video display defined in claim 1, wherein the video signal comprises signal portions that identify whether the video is recorded in a 2D mode or a 3D mode and the controller responds to those video portions for said switching.

7. The video display defined in claim 6 wherein the signal portions comprise VITS.

8. The video display defined in claim 6 wherein the signal portions comprise TeleText.

9. The video display defined in claim 6 wherein the signal portions comprise portions of one or more video lines.

10. The video display defined in claim 6, wherein the video signal comprises an MPEG file and the MPEG file includes one or more tags identifying that the video is recorded in one of a 2D mode and a 3D mode.

11. A video display comprising:
first and second display screens; and
a controller receiving video signals and data signals, the controller switching between displaying the video signals on the first and second display screens in a two-dimensional mode and a three-dimensional mode based on the data signals.

12. The video display defined in claim 111 wherein the controller generates query signals and receives the data signals in response to the query signals.

13. The video display defined in claim 12 wherein the controller generates a query signal upon synchronizing to a video signal.

14. The video display defined in claim 11 wherein the video signals and data signals correspond to content contained in a portable digital video file.

15. The video display defined in claim 14 wherein the portable digital video file comprises an MPEG file.

16. The video display defined in claim 14 wherein the portable digital video file comprises at least one tag.

17. The video display defined in claim 16 wherein the at least one tag comprises information relating to whether the video signals are to be displayed on the first and second screens in one of a two-dimensional format, a three-dimensional format, and a reverse three-dimensional format.

18. A method of displaying video on a personal video display device having first and second display screens, said method comprising the steps of:
receiving video content including video signals in the video display device from a source;
selecting whether the video signals should be displayed on the personal video display device in one of a two-dimensional mode and three-dimensional mode;
displaying identical video signals at the same time on each of the first and second display screens when a two-dimensional mode is selected in the selecting step; and
displaying different video signals at the same time on each of the first and second display screens when a three-dimensional mode is selected in the selecting step.

19. The method of claim 18, wherein the video content further includes additional data containing information regarding whether the video signals should be displayed in a two-dimensional format or in a three-dimensional format, and the selection is made in the selecting step based on the additional information.

20. The method of claim 18, wherein the video content is corresponds to data stored in an MPEG file and the additional information is contained in a tag associated with the MPEG file.

21. The method of claim 18, further comprising the step of adding data to a tag contained in the video content, the data defining whether the video signals should be displayed in a two-dimensional format or in a three-dimensional format.

22. The method of claim 18, further comprising a step of querying the device, upon synchronization of the video signals, to obtain data regarding whether the video should be displayed in two-dimensional format or three-dimensional format, and wherein the selection step is made based on the data obtained in the querying step.
